(19) United States
(12) Patent Application Publication
(10) Pub. No.: US 2022/0393869 A1
(43) Pub. Date: Dec. 8, 2022

(54) RECOVERY KEYS

(71) Applicant: Hewlett-Packard Development Company, L.P., Spring, TX (US)

(72) Inventors: Adrian John Baldwin, Bristol (GB); Stuart Lees, Bristol (GB); Jonathan Griffin, Bristol (GB); Daniel Ellam, Bristol (GB)

(21) Appl. No.: 17/755,011

(22) PCT Filed: Nov. 22, 2019
(86) PCT No.: PCT/US2019/062756

§ 371 Date: Apr. 19, 2022

(51) Int. Cl. H04L 9/08; H04L 9/40

(52) U.S. Cl. CPC H04L 9/0894; H04L 9/0825; H04L 63/062; H04L 63/126

(57) ABSTRACT

In some example, a method for accessing a cryptographic recovery key of an encryption system of a device comprises mapping a device identity received at a key management system to a recovery key stored in the key management system, specifying at least one device-related operation to which the recovery key is linked, generating an encrypted message for the device, the encrypted message comprising the recovery key, and transmitting the encrypted message and a signed message to the device.

### BACKGROUND

An endpoint device, such as a computing platform for example, can use a variety of different operating systems (OS) that may be located on a local storage apparatus of the device. Such a local storage apparatus can be encrypted with access provided during a boot cycle of the main installed OS of the device.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 is a schematic representation of a method for accessing a cryptographic recovery key of a device according to an example;

FIG. 2 is a flow chart of a method for accessing a cryptographic recovery key of a device according to an example; and

FIG. 3 is a schematic representation of a key/image manager system according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

An endpoint device, such as a user device in the form of a computer, laptop or other computing or smart apparatus for example, may be able to use a variety of different operating systems. In general, such operating systems are provided on a local storage location of the device in question, such as a hard disk or solid-state drive for example. At device boot time, the local storage apparatus can be unlocked from an encrypted state using an encryption key provided as part of an encryption mechanism.

In an example, an endpoint device may be booted using an OS other than one that is installed in a local storage location of the endpoint device, or by another device. For example, a device at a location that is remote from the endpoint device can be used to boot to the endpoint device, e.g. into a recovery state. In another example, an endpoint device can be booted using an OS that does not otherwise form part of an OS installed on the endpoint device.

When the endpoint device is booted from another OS or device, the encrypted drive remains locked unless the encryption keys are provided. A disk encryption mechanism, such as Microsoft's bitlocker for example, protects the disk encryption keys by sealing them within a trusted platform module (TPM) using Platform Configuration Registers (PCRs) containing measurements of the OS boot. Accordingly, the key(s) to decrypt a local storage apparatus become available when the appropriate Windows boot mechanism is used.

A user (endpoint) device can become inoperable or compromised for a number of reasons. For example, a device OS that is provided on a local storage of the device may become corrupted due to general filesystem or upgrade issues, or may become infected by malware. For example, operating systems are continually under attack from various actors wishing to find an exploit that lets them run their own software or malware, such as but not limited to, remote access trojans, ransomware or cryptocurrency miners. There also can be other issues, software or hardware, that render the endpoint device compromised, unbootable or unusable.

In some cases, such as when the OS is corrupted or may have a malware infection it can be useful to decrypt the disk and boot to an alternative diskless boot image for clean up or recovery for example. However, such images do not have easy access to the disk encryption keys (e.g. bitlocker keys). For example, in the case of bitlocker, an enterprise can keep recovery keys for a device within an active directory with appropriate access controls so that the user and administrators can access the keys. For consumers or small/medium enterprises and so on, keys may be held in a controlled manner within an online storage system. However, the interfaces to these key recovery systems do not typically allow for easy automation of recovery diskless boot images as a decryption key will normally be accessed by a user via a different system after having typed in a long string to enable access.

According to an example, there is provided a method for automated access and/or retrieval of a cryptographic recovery key (or keys) of an encryption system of a device to enable access to a local storage device of the device by, e.g., a diskless boot image. That is, in an example, there is provided a mechanism to enable a trusted bootless disk image (such as a Win PE/RE image for example) to access a recovery key of a logical volume encryption system (e.g. bitlocker) in an automated way, thereby enabling the trusted diskless image to access the disc of a system or endpoint device. Once access is established, scripts, such as recovery and/or analysis scripts can be executed on the endpoint device.

According to an example, an endpoint device can be booted using a trusted diskless boot image in response to a trigger mechanism. The trigger mechanism can be user or system initiated. For example, the endpoint device may be booted using the trusted image as a result of an automatic trigger stemming from the possible existence of malware on the system (e.g. as a result of an antivirus scan and a subsequent detection of possible malware that initiates a response in the form of a trigger). Alternatively, a user may be prompted, or choose, to boot using a trusted disk image at boot time. For example, this could be in response to results from a previous antivirus scan as described above, or in response to an instruction to prompt the user from a third party, such as a device administrator or enterprise. Alternatively, the endpoint device can be booted using a trusted disk image automatically in response to an external instruction, e.g. from an enterprise, without end user intervention. In an example, a device hardware component, e.g., firmware, can be used to perform device hardware initialization during a boot process. The device hardware component can also provide runtime services for operating systems and programs, and will typically be a pre-installed component on the device. Such a device hardware component can be referred to as a BIOS (basic input/output system), and may be provided in the form one or more components such as integrated circuits. References herein to BIOS represent any suitable device hardware component that can be used to perform device hardware initialization during a device boot process.

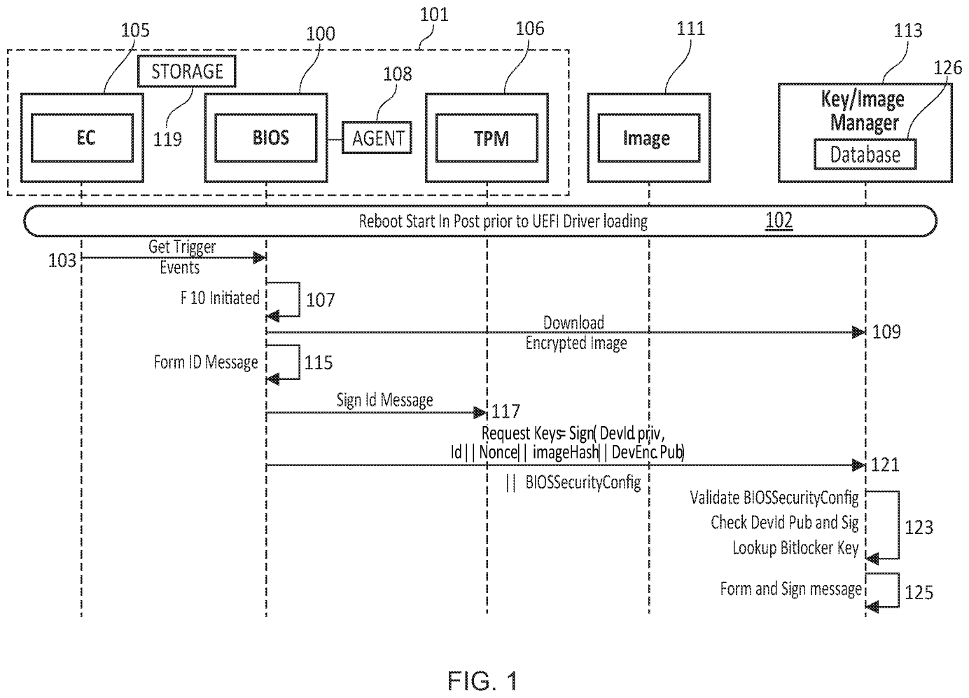

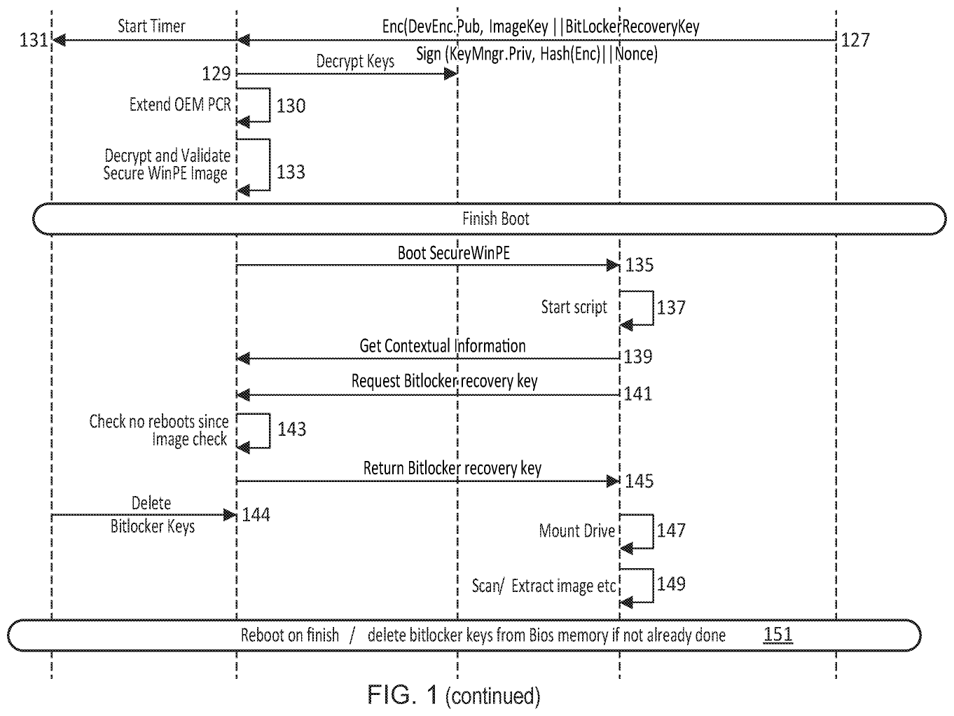

FIG. 1 is a schematic representation of a method for accessing a cryptographic recovery key of a device according to an example. In the example of FIG. 1, the BIOS 100 of an endpoint device 101 can receive a trigger event 103. In the example of FIG. 1, a trigger event 103 can be received at BIOS 100 from a device security controller (EC) 105. In an example, EC 105 in a role as trusted management component for the device can manage a trigger event that is received from another component of the device in order to make the trigger event available at boot time. EC 105 can store a trigger event that has been provided to it via secure communications from an agent running within the OS, or a management agent (in the OS or via an alternative channel). In an example, this can be in response to e.g. results of an antivirus scan. An alternative trigger can be as the BIOS boots the user may go into the BIOS menu (e.g. by pressing f10) and request a service which uses an alternative boot and access to encryption keys.

Thus, EC 105 may store a trigger event initiated in response to e.g. results of an antivirus scan as described above, or in response to user input or an instruction from a third party such as an enterprise that manages a security policy for the device 101. In another example, a trigger event 103 can be received by BIOS 100 following a check performed at device reboot 102. For example, at reboot, any trigger events in EC 105 that may have been stored as a result of an issue at runtime of the device (e.g. detection of malware) can be passed to BIOS 100 before device 101 boots. That is, a trigger event 103 can comprise an instruction that is executed or acted upon on reboot of a device in order to force the device into a BIOS configuration state. In the example of FIG. 1, a trigger event 103 can be received by BIOS 100 following a reboot, but before any device drivers have been loaded into a system memory.

In an example, BIOS 100 can download 109 an image 111, such as a trusted diskless boot image from an image manager 113, which can be in the form of a remote repository storing the image, e.g. a cloud-based enterprise storage location.

According to an example, image 111 can be downloaded using an agent 108, within the BIOS that can download the image 111 into memory (or retrieve it from a local storage) in the form of a ram disk so that it can then boot. Once downloaded to, e.g., a local storage 119 of device 101, image 111 can be checked to ensure that it is signed. Version information for the image can also be checked using information configured into the BIOS 100 (or EC 105) for example. In an example, such checks can be performed using the agent 108. Other BIOS based mechanisms could provide a similar process to download and boot a trusted diskless image.

In the example of FIG. 1, BIOS 100 forms a message 115 that is signed 117 by TPM 106 using a device identity key (PlatKeySign.Private). The message 115 is a message for the management system 113 that is used to request a key that can be used to enable services outside of a normal OS boot of device 101. As noted above, scripts can be automated that can run within the known and trusted image 111 (which can be a diskless boot version of windows such as Windows PE or RE for example) to access a local storage of device 101 that is encrypted, such as by way of a mechanism such as Bitlocker for example. Thus, message 115 provides a request for a recovery key(s) that can be used to access an encrypted local storage 119 of device 101. The device identity key (PlatKeySign.Private) will be identified as a key within the platform hierarchy of the TPM and the TPM can be used to validate this. This ensures that the signing key can be used under the control of the BIOS and hence in a higher level of trust to the OS.

Thus, according to an example, following reboot, device 101 can check to see if it has reason to boot into a trusted diskless image 111, e.g. because of user intervention (107), or because of a trigger event 103. If there is reason, device 101 can download the image 111 from a location 113 that has been configured by, e.g. an enterprise management system. In an example, image 111 can be an encrypted image, and can be pre-encrypted to ensure that an attacker cannot easily reverse engineer it for example.

According to an example, message 117 comprises a hash of the image 111 (e.g. if message generation is performed after the download of the image 111 rather than concurrently), a nonce (which could be generated using the TPM 106), an identity of the device, PlatKeySign.Pub, and PlatKeyEnc.Pub.

TPM 106 signs 117 message 115 with a device identity or cryptographic key (PlatKeySign.Private). In an example, the TPM 106 can hash the message 115 as the key is a restricted signing key.

The signed message is sent 121 to the Key management service 113 along with a BIOS state attestation message (e.g. relevant signed information recording the configuration of the BIOS 100 in the form of BIOSSecurityConfig with reference to FIG. 1). Thus, BIOS 100 contacts a KeyManager service 113 in order to obtain a Bitlocker/encryption recovery key(s) for use with the trusted image 111.

According to an example, the KeyManager service 113 checks (123) the signing of the message 115 and checks against a known PlatKeySign.Pub (Identity) for device 101 (as obtained from e.g. the management and BIOS State Attestation records or as a device ID). If the hash of the image 111 is included, the KeyManager service 113 can check that this matches the hash of the latest (possibly encrypted) image. The key manager service can also check that it has not seen the nonce before from that device, thus preventing a replay of the request.

The Key manager service 113 can then then look up the requested encryption key in a database 126 to enable access a local storage 119 of device 101. Alternatively, a user could log into a web site (e.g. via a smart device using a QR code) and authorise the release of the recovery key using, for example, their authorised enterprise domain credentials.

The Key manager 113 forms and signs a message 125 comprising the requested encryption key. In an example, Key manager 113 encrypts this key using the PlatKeyEnc.Pub key along with any encryption key associated with the image 111 (e.g. to decrypt it in the case that it is in an encrypted form). If the PlatKeyEnc.pub key was pre-registered the encryption recovery keys can be encrypted for each device with its PlatKeyEnc.pub key. This can make the key manager less attackable. If this approach is taken, a registration phase can be used in which the PubKeyEnc.Pub key is passed with BIOS State Attestation data. In an example, this can have a certification signed with PlatKeySign to demonstrate that the encryption key is a TPM key with appropriate limitations.

In an example, the Key Manager 113 signs the hash of the encrypted payload along with the nonce from the request 121. The Key Manager 113 returns 127 the encrypted keys (the bitlocker recovery key and image encryption key) along with the signed structure to BIOS 100. A secure timer can be started 131 within the EC 105 to set a maximum lifetime for keys. In an example, the BIOS 100 can check the signed structure using a public key provided through the Enterprise management system 113 and stored within the EC 105. The BIOS 100 can also check the nonce in the signed structure to ensure that it matches the one it sent in request 121.

Assuming the TPM Keys are finished with the BIOS can make the keys unusable either by extending a PCR used to seal the keys or by resetting the authorization value of the TPM platform hierarchy to a random value.

The BIOS can decrypt the image (if it was encrypted) and validate (133) the image by:

checking its hash matches any in the message back from the key manager 113, and checking the signature of the image (shipped with the image) using a public key from the BIOS state.

The BIOS 100 boots 135 the trusted diskless image. In an example, the trusted diskless image can comprise an OS, such as Win PE or RE. Accordingly, when booted, the device 101 runs a trusted OS.

According to an example, BIOS 100 passes (145) the recovery key along with any contextual information 139 about why the trusted image is being booted to the running OS (from the trusted image) following a request 141 from image 111. This can be performed either through a WMI request from the OS or via UEFI variables for example. Using the recovery key, the image 111 mounts 147 the storage location 119 of device 101. In an example, image 111 can execute a predefined payload 149 that can vary according to the contextual information. For example, a trusted OS executing as part of the mounted image 111 can execute a script selected on the basis of contextual information received from BIOS 100. In an example, contextual information can include information relating to the results of an antivirus scan.

In an example, once booted, the image can have been configured to not allow user activity, but instead execute a script. In an example, the script can pick up any contextual information from the BIOS through a WMI call (or a UEFI variable) to determine actions to be taken.

According to an example, the script can pick-up the encryption recovery key from BIOS using a WMI Call (or UEFI variable). The BIOS checks (143) that no reboots have happened since the Secure image boot (or remove the key if any has happened). If an EC timer (131) has started it checks that the keys should still be usable and have not passed any time-based limits.

In an example, a main encrypted partition of storage 119 can be mounted (147) using the encryption recovery key. After the EC timer time out then the encryption keys are deleted (144) from memory to minimise any exposure. The script scans, collects data or collects forensic information 149 as setup by the enterprise, and, once complete, the image 111 shuts down. On a reboot the encryption keys and any other state can be deleted as part of the reboot process 151.

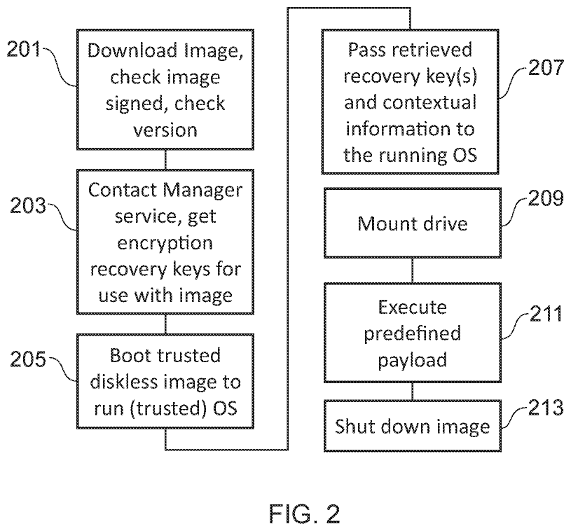

FIG. 2 is a flow chart of a method for accessing a cryptographic recovery key of an encryption system of a device according to an example. In block 201 BIOS 100 downloads the Image 111 and checks the image is signed as well as checking any version using information configured into the BIOS. In an example, this can be performed via a mechanism for downloading a recovery agent. For example, as described above, a recovery agent can be downloaded (or stored locally) and placed into memory of device 101 in the form of a ram disk so that it can then boot. In block 203 the BIOS 100 contacts a Key Manager service 113 and retrieves an encryption recovery key or keys (e.g. a bitlocker key or keys) for use with the downloaded secure image 111.

In block 205, the BIOS 100 boots the trusted diskless image so that it is a running a trusted OS. In block 207, the BIOS 100 passes the retrieved recovery key(s) along with any contextual information about why the trusted image is being booted to the running OS (from the trusted image), e.g. through a WMI request from the OS or via UEFI variables. In block 209 the Secure image mounts an encrypted drive of device 101. For example, storage location 119 can be an encrypted drive of device 101, or may comprise an encrypted portion, either of which can store the main OS for the device 101 for example.

In block 211 the secure image runs a predefined payload that can vary according to the contextual information. In an example, a trusted OS executing via the secure image can be used to execute a script that can use contextual information from the BIOS 100 to determine a methodology for scanning and/or resolving issues that may have been the cause of the secure boot process being initiated. In block 213 the Secure image shuts down.

According to an example, security is maintained due to the trusted state of the device 101 pre-booting the OS and using this to ensure a specified (trusted) image 111 is booted that this trusted image is provided with an encryption key for the storage 119 of the device 101. In an example, the trusted diskless image is locked down so when it has access to a main disk (119) of a device it runs intended functions and offers a user or attacker no interface to change the device.

According to an example, the provision of enabling access to a storage location 119 of device 101 is underpinned by having a strong identity on the local device 101. In an example, this can be provided by a device Identity which is controlled by the TPM 106 and available at boot time. Alternatively, management system 113 can have a TPM based public key (within the platform hierarchy) that can be linked to a TPM endorsement certificate or/and tracked over time. Using either mechanism, management system 113 can maintain a public key that represents the device 101 and that can be used as an identifier to the management system. In an example, the identity can comprise a public private key pair with the private key within the platform hierarchy of the TPM 106. In the example of FIG. 1, the identity is referred to in terms of ‘PlatKey.Sign.Public’. However, this may be a key associated with a device and registered with a management system on first enrolment or it could have an associated device Id certificate that includes the public key and device identifiers and signed by a platform vendor key.

In an example, the use of the Secure image 111 can be triggered either through a trigger (107) created by the enterprise management system, local security agent or via a user request using a function key at boot, e.g. F10 or F11.

According to an example, a cryptographic identity of device 101 can be registered at the Key Management service 113. The identity can be associated with or mapped to a disk encryption key in order to enable the service 113 to pair a request from a device for a disk encryption key to a corresponding disk encryption key for that device. In an alternative example, a device public encryption key can be stored along with a disk encryption key or used to encrypt the disk encryption key. The associated private key can be made available to the device during the POST (preboot—102) to enable it to decrypt the disk encryption key. In another example, if the recovery key can be securely delivered to the BIOS, the encrypted recovery key can be kept within the BIOS for use during this phase.

In an alternative example an encryption key can be requested first and an access token can be provided to allow access to an image. The ‘Request encryption key’ message can still contain an encryption key and image hash to ensure the latest image is being used. The access token can be used to protect an image on an open server. That is, the download of the image 111 proceeds after the request for the key, with a token being provided in response to the request to enable the image to be retrieved. It is also possible that if there are identity keys in the EC 105 these could be used instead of TPM based keys.

In an example, hardware policies could be returned with the encryption key (127) to instruct the BIOS 100 to e.g. lock down hardware devices (wireless, Bluetooth, USB, Network, Keyboard and so on). By disabling hardware at this level, the attack surface for the Secure image is reduced in case an attacker tries to use it to obtain the encryption keys for example.

In an example, a local TPM encrypted version of a recovery key can be held within the BIOS or EC of device 101 and accessible during POST (102). The BIOS can decrypt this when an appropriate trusted diskless image is booted. Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, agent 108) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

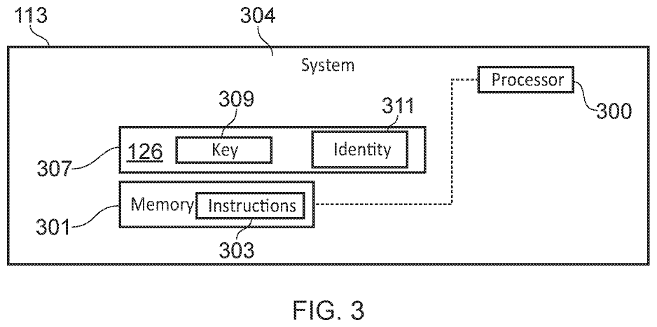

FIG. 3 is a schematic representation of a key/image manager system 113, also referred to as a management service, according to an example. System 113 comprises a processor 300 associated with a memory 301. The memory 301 comprises computer readable instructions 303 which are executable by the processor 300. The instructions 303 can comprise instructions to: map a device (101) identity 311 received at the key management system 113 to a recovery key 309 stored in the key management system (such as in database 126 for example); generate an encrypted message (125) for the device 101, the encrypted message comprising a recovery key; and transmit (127) the encrypted message and a signed message to the device 101. In an example, instructions 303 can be executed by processor 300 in response to a request 121 from BIOS 100 of device 101.

Such machine readable instructions 303 may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in FIGS. 1 and 2.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for accessing a cryptographic recovery key of an encryption system of a device, the method comprising:
mapping a device identity received at a key management system to a recovery key stored in the key management system;
specifying at least one device-related operation to which the recovery key is linked;
generating an encrypted message for the device, the encrypted message comprising the recovery key; and
transmitting the encrypted message and a signed message to the device.

2. The method as claimed in claim 1, wherein the recovery key is linked to enable access, by a trusted diskless operating system image, to a logical volume of the device.

3. The method as claimed in claim 1, wherein the signed message comprises a hash of the encrypted message, and a nonce received from the device.

4. The method as claimed in claim 1, further comprising:
receiving a request at the key management system comprising a hash of a data image; and
validating the hash of the data image; and
on the basis of the validation, providing the encrypted message.

5. The method as claimed in claim 4, wherein the data image is encrypted using an image key, the method further comprising providing the image key as part of the encrypted message for the device, whereby to enable the device to decrypt the data image.

6. The method as claimed in claim 1, further comprising:
receiving contextual information; and
generating a script for execution via a data image on the basis of the contextual information.

7. The method as claimed in claim 1, further comprising:
providing direct access to a data image.

8. The method as claimed in claim 1, further comprising:
providing access to a token to enable access to a data image.

9. The method as claimed in claim 2, further comprising:
providing at least one hardware policy associated with the recovery key specifying at least one device hardware component to be disabled prior to boot of the trusted diskless operating system image.

10. The method as claimed in claim 9, further comprising instructing a device hardware component, based on the hardware policy, to disable the at least one device hardware component.

11. A device, comprising:
a device hardware component to request a recovery key stored in a key management system;
a trusted platform module component to decrypt a recovery key received in encrypted form at the device, the recovery key linked to at least one device-related operation; and
a storage location comprising an encrypted portion accessible using the recovery key.

12. The device as claimed in claim 11, the device hardware component further to download a data image on the basis of a trigger event.

13. The device as claimed in claim 11, the trusted platform module component to control an identity used to sign a message representing the request for a recovery key.

14. A machine-readable storage medium encoded with instructions for accessing a cryptographic recovery key of an encryption system of a device, the instructions executable by a processor of an apparatus to cause the apparatus to:
receive a request for a recovery key from a device, the recovery key linked to at least one device-related operation;
map a device identifier associated with request to a recovery key for the device; and
generate a signed response to the request comprising an encrypted version of the recovery key.

15. The machine-readable storage medium as claimed in claim 14, further encoded with instructions to disable at least one device hardware component prior to boot of the trusted diskless operating system image.
